(19) United States
(12) Patent Application Publication
(10) Pub. No.: US 2026/0319687 A1
(43) Pub. Date: Oct. 15, 2026

(54) MEMORY MANAGEMENT METHOD AND STORAGE DEVICE

(71) Applicant: Hosin Global Electronics Co., LTD, Shenzhen (CN)

(72) Inventors: Wen Hao Li, Shenzhen (CN); Hui Ding, Shenzhen (CN); Wei Wang, Shenzhen (CN); Tsung-Lin Wu, Shenzhen (CN); Chao-Yu Chen, Shenzhen (CN); Xiang Ming Yang, Shenzhen (CN); Jian Feng Ye, Shenzhen (CN); Yun-An Fan, Shenzhen (CN)

(73) Assignee: Hosin Global Electronics Co., LTD, Shenzhen (CN)

(21) Appl. No.: 19/693,558

(22) Filed: Jun. 1, 2026

(30) Foreign Application Priority Data
Jun. 25, 2025 (CN) 202510862437.4

(51) Int. Cl. G06F 3/06

(52) U.S. Cl. CPC G06F 3/0647; G06F 3/0604; G06F 3/0679

(57) ABSTRACT

Disclosed are a memory management method and a storage device. The method includes: detecting an access event, wherein the access event reflects that a first physical unit among the plurality of physical units is accessed; determining, through a Cuckoo filter, whether a hit event corresponding to the first physical unit occurs according to the access event; if the hit event occurs, updating hit count information corresponding to the first physical unit; and if the hit count information meets a preset condition, migrating first identification information corresponding to the first physical unit from a first information queue to a second information queue.

### CROSS-REFERENCE TO RELATED APPLICATION

This application claims the priority benefit of China application serial no. 202510862437.4, filed on Jun. 25, 2025. The entirety of the above-mentioned patent application is hereby incorporated by reference herein and made a part of this specification.

### BACKGROUND

### Technical Field

The present disclosure relates to the field of storage technology, and in particular to a memory management method and a storage device.

### Related Art

With the rapid development of information technology, data volumes have exhibited exponential growth, thereby imposing heightened requirements on the capacity, performance, and reliability of storage systems. In this context, solid-state drives (SSDs), which employ NAND flash as the storage medium, by virtue of their advantages of high read/write speed, low power consumption, compact size, and resistance to shock and impact, have begun to supplant traditional hard disk drives in many fields. However, flash memory possesses particular physical characteristics—namely, an erase-before-write constraint, a finite number of program/erase (P/E) cycles, and an organizational structure including pages, blocks, and planes—which render the efficient execution of garbage collection (GC), and in particular the identification and management of hot and cold data, critical to improving SSD performance and extending service life.

To accommodate the foregoing characteristics and to optimize SSD performance, the Flash Translation Layer (FTL) has become an indispensable component, responsible for, inter alia, address mapping, garbage collection, and wear leveling. Among these functions, the identification of hot data is essential to enhancing the efficiency of garbage collection, reducing the overhead associated with copying and moving valid data, and improving wear leveling. Conventional hot data identification methods—such as counter-based approaches, Bloom filters, and techniques predicated on the least recently used (LRU) principle—each have advantages, but also suffer from issues including substantial memory overhead, elevated false-positive rates, or a failure to adequately account for workload locality characteristics.

Concurrently, as data volumes within storage systems increase, garbage collection, as a core mechanism for optimizing storage resource management, has garnered widespread attention. Effective garbage collection strategies may strike a balance between reducing latency and increasing throughput; however, existing techniques—such as Bloom filters, which cannot dynamically delete elements and thereby incur additional memory overhead; probabilistic filters, whose higher false-positive rates accelerate NAND wear; and fixed-capacity LRU lists, which exhibit insufficient adaptability to bursty workloads—collectively constrain further improvements in SSD performance.

### SUMMARY

The present disclosure provides a memory management method and a storage device, which may overcome the above problems, thereby improving the management efficiency of the storage device.

An embodiment of the present disclosure provides a memory management method for a storage device, wherein the storage device includes a memory module. The memory module includes a plurality of physical units, and the memory management method includes: detecting an access event, wherein the access event reflects that a first physical unit among the plurality of physical units is accessed; determining, through a Cuckoo filter, whether a hit event corresponding to the first physical unit occurs according to the access event; if the hit event occurs, updating hit count information corresponding to the first physical unit; if the hit count information meets a preset condition, migrating first identification information corresponding to the first physical unit from a first information queue to a second information queue; and if the hit count information does not meet the preset condition, storing the first identification information in the first information queue.

An embodiment of the present disclosure further provides a storage device, which includes a connection interface, a memory module, and a memory controller. The connection interface is configured to connect to a host system. The memory controller is connected to the connection interface and the memory module. The memory module includes a plurality of physical units, and the memory controller is configured to: detect an access event, wherein the access event reflects that a first physical unit among the plurality of physical units is accessed; determine, through a Cuckoo filter, whether a hit event corresponding to the first physical unit occurs according to the access event; if the hit event occurs, update hit count information corresponding to the first physical unit; if the hit count information meets a preset condition, migrate first identification information corresponding to the first physical unit from a first information queue to a second information queue; and if the hit count information does not meet the preset condition, store the first identification information in the first information queue.

### BRIEF DESCRIPTION OF THE DRAWINGS

FIG. 1 is a schematic diagram of a data storage system according to an embodiment of the present disclosure.

FIG. 2 is a schematic diagram of a memory controller according to an embodiment of the present disclosure.

FIG. 3 is a schematic diagram of managing a memory module according to an embodiment of the present disclosure.

FIG. 4 is a schematic diagram of generating first fingerprint information and a plurality of index information according to first identification information according to an embodiment of the present disclosure.

FIG. 5 is a schematic diagram of a bucket structure for querying a Cuckoo filter according to an embodiment of the present disclosure.

FIG. 6 is a schematic diagram of a first information queue and a second information queue according to an embodiment of the present disclosure.

FIG. 7 is a flowchart of a memory management method according to an embodiment of the present disclosure.

### DESCRIPTION OF THE EMBODIMENTS

Now, exemplary embodiments of the present disclosure will be described in detail, and examples of the exemplary embodiments are illustrated in the accompanying drawings. Wherever possible, the same element symbols are used in the drawings and the description to represent the same or similar parts.

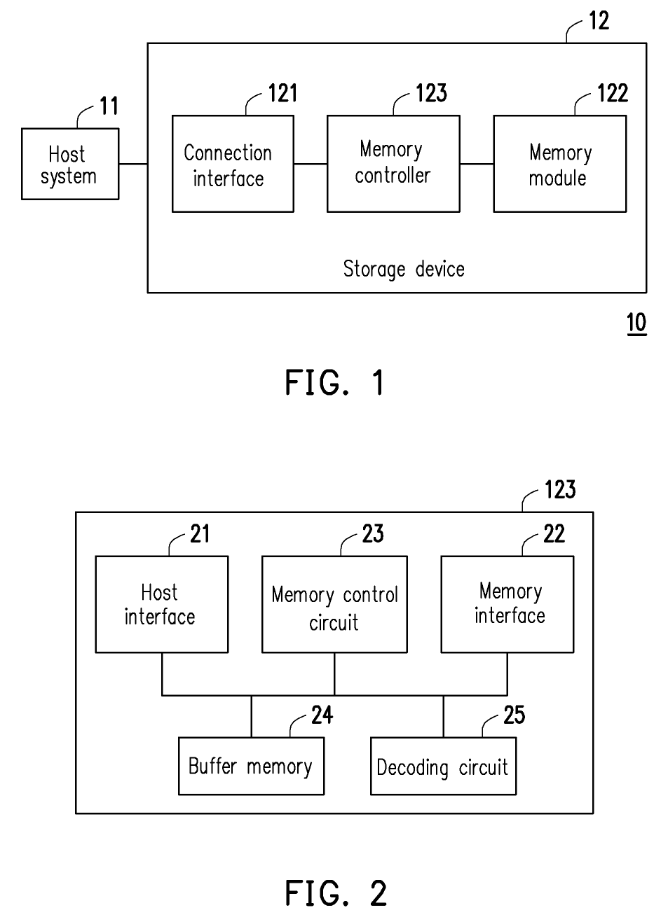

FIG. 1 is a schematic diagram of a data storage system according to an embodiment of the present disclosure. Please refer to FIG. 1, a data storage system 10 includes a host system 11 and a storage device 12. The storage device 12 may be connected to the host system 11 and may be used to store data from the host system 11. For example, the host system 11 may be a smartphone, a tablet computer, a notebook computer, a desktop computer, an industrial computer, a game console, a server, or a computer system disposed in a specific carrier (e.g., a vehicle, an aircraft, or a vessel), and the type of the host system 11 is not limited thereto. In addition, the storage device 12 may include a solid-state drive, a USB flash drive, a memory card, or other types of non-volatile storage devices.

The storage device 12 includes a connection interface 121, a memory module 122, and a memory controller 123. The connection interface 121 is configured to connect the storage device 12 to the host system 11. For example, the connection interface 121 may support embedded Multi-Media Card (eMMC), Universal Flash Storage (UFS), Peripheral Component Interconnect Express (PCI Express), Non-Volatile Memory Express (NVM express), Serial Advanced Technology Attachment (SATA), Universal Serial Bus (USB), or other types of connection interface standards. Therefore, the storage device 12 may communicate with the host system 11 via the connection interface 121 (e.g., exchange signals, instructions, and/or data).

The memory module 122 is configured to store data. For example, the memory module 122 may include one or more rewritable non-volatile memory modules. Each rewritable non-volatile memory module may include one or more storage unit arrays. The storage units in the storage unit array store data in the form of voltages (also referred to as threshold voltages). For example, the memory module 122 may include a Single Level Cell (SLC) NAND flash memory module, a Multi Level Cell (MLC) NAND flash memory module, a Triple Level Cell (TLC) NAND flash memory module, a Quad Level Cell (QLC) NAND flash memory module, and/or other memory modules having the same or similar characteristics.

The memory controller 123 is connected to the connection interface 121 and the memory module 122. The memory controller 123 may be regarded as the control core of the storage device 12 and is configured to control the storage device 12. For example, the memory controller 123 may be configured to control or manage all or part of the operations of the storage device 12. For example, the memory controller 123 may include a Central Processing Unit (CPU), or other programmable general-purpose or special-purpose microprocessors, a Digital Signal Processor (DSP), a programmable controller, Application Specific Integrated Circuits (ASIC), a Programmable Logic Device (PLD), or other similar devices or a combination of these devices. In an embodiment, the memory controller 123 may include a flash memory controller.

The memory controller 123 may send instruction sequences to the memory module 122 to access the memory module 122. For example, the memory controller 123 may send a write instruction sequence to the memory module 122 to instruct the memory module 122 to store data into specific storage units. For example, the memory controller 123 may send a read instruction sequence to the memory module 122 to instruct the memory module 122 to read data from specific storage units. For example, the memory controller 123 may send an erase instruction sequence to the memory module 122 to instruct the memory module 122 to erase data stored in specific storage units. In addition, the memory controller 123 may further send other types of instruction sequences to the memory module 122 to instruct the memory module 122 to perform other types of operations, which are not limited by the present disclosure. The memory module 122 may receive the instruction sequence from the memory controller 123 and access the storage units inside the memory module 122 according to the instruction sequence.

FIG. 2 is a schematic diagram of a memory controller according to an embodiment of the present disclosure. Please refer to FIGS. 1 and 2, the memory controller 123 includes a host interface 21, a memory interface 22, and a memory control circuit 23. The host interface 21 is configured to connect to the host system 11 via the connection interface 121 to communicate with the host system 11. The memory interface 22 is configured to connect to the memory module 122 to access the memory module 122.

The memory control circuit 23 is connected to the host interface 21 and the memory interface 22. The memory control circuit 23 may be configured to control or manage all or part of the operations of the memory controller 123. For example, the memory control circuit 23 may communicate with the host system 11 via the host interface 21 and access the memory module 122 via the memory interface 22. For example, the memory control circuit 23 may include a control circuit such as an embedded controller or a microcontroller. In the following embodiments, the description of the memory control circuit 23 is equivalent to the description of the memory controller 123.

In an embodiment, the memory controller 123 may further include a buffer memory 24. The buffer memory 24 is connected to the memory control circuit 23 and is configured to buffer data. For example, the buffer memory 24 may be configured to buffer instructions from the host system 11, data from the host system 11, and/or data from the memory module 122.

In an embodiment, the memory controller 123 may further include an encoding/decoding circuit 25. The encoding/decoding circuit 25 is connected to the memory control circuit 23 and is configured to perform encoding and decoding on data to ensure the correctness of the data. For example, the encoding/decoding circuit 25 may support Low Density Parity Check code (LDPC code), BCH code, Reed-solomon code (RS code), Exclusive OR (XOR) code, and other various encoding/decoding algorithms. In an embodiment, the memory controller 123 may further include other types of various circuit modules (e.g., power management circuits, etc.), which are not limited by the present disclosure.

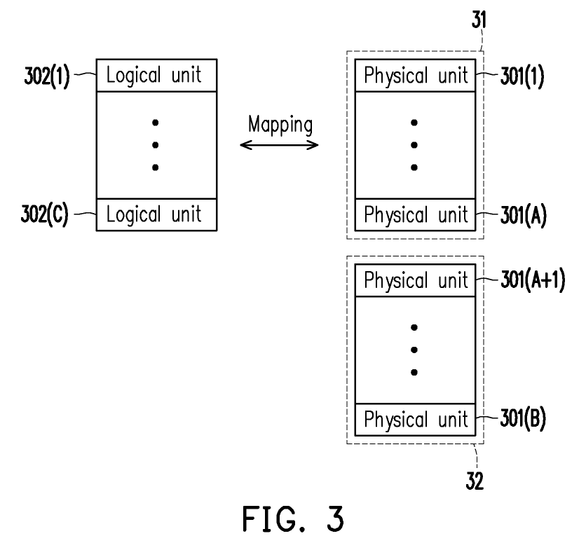

FIG. 3 is a schematic diagram of managing a memory module according to an embodiment of the present disclosure. Please refer to FIGS. 1 to 3, the memory module 122 includes a plurality of physical units 301(1) to 301(B). Each physical unit includes a plurality of storage units and is configured to store data in a non-volatile manner.

In an embodiment, the memory module 122 may include a plurality of physical management units. For example, a physical management unit may span multiple chips and/or multiple planes in the memory module 122. For example, a chip may include multiple planes. The memory controller 123 may manage the memory module 122 based on the plurality of physical management units. In addition, the memory controller 123 may synchronously perform data access on a plurality of physical units belonging to the same physical management unit to improve work performance. In an embodiment, a physical management unit is also referred to as a virtual block.

In an embodiment, each physical management unit may include a plurality of physical units. For example, a physical unit may refer to a physical erase unit. Each physical unit may include a plurality of sub-physical units. For example, a sub-physical unit may refer to a physical program unit (also referred to as a physical programming unit).

In an embodiment, a physical program unit may include a plurality of physical sectors. For example, the data capacity of a physical sector may be 512 bytes (B), and a physical program unit may include 32 physical sectors. However, the data capacity of a physical sector and/or the total number of physical sectors included in a physical program unit may be adjusted according to practical requirements, which are not limited by the present disclosure. In an embodiment, a physical program unit may be regarded as a physical page. For example, the storage capacity of a physical program unit may be 16 kilobytes, and the present disclosure is not limited thereto.

In an embodiment, a physical program unit is a minimum unit for synchronously writing data in the memory module 122. For example, when performing a program operation (also referred to as a write operation) on a physical program unit to write data into the physical program unit, a plurality of storage units in the physical program unit may be synchronously programmed to store the corresponding data. For example, when programming a physical program unit, a write voltage may be applied to the physical program unit to change the threshold voltage of at least some of the storage units in the physical program unit. For example, a threshold voltage of a storage unit may reflect the bit data stored in the storage unit.

In an embodiment, a plurality of physical program units in a physical erase unit may be synchronously erased. For example, when performing an erase operation on a physical erase unit, an erase voltage may be applied to the plurality of physical program units in the physical erase unit to change the threshold voltage of at least some of the storage units in the physical program units. By performing an erase operation on a physical erase unit, the data stored in the physical erase unit may be cleared. In an embodiment, a physical erase unit may be regarded as a physical block.

In an embodiment, the memory control circuit 23 may logically associate the physical units 301(1) to 301(A) and 301(A+1) to 301(B) with a data region 31 and a free region 32, respectively. The physical units 301(1) to 301(A) in the data region 31 all store data (also referred to as user data) from the host system 11. For example, any one of the physical units in the data region 31 may store valid data and/or invalid data. In addition, the physical units 301(A+1) to 301(B) in the free region 32 do not store any data (e.g., valid data).

In an embodiment, if a specific physical unit does not store the valid data, the physical unit may be associated with the free region 32. In addition, the physical units in the free region 32 may be erased to clear the data in the physical units. In an embodiment, the physical units in the free region 32 are also referred to as free physical units. In an embodiment, the free region 32 is also referred to as a free pool.

In an embodiment, when data is to be stored, the memory control circuit 23 may select one or more physical units from the free region 32 and instruct the memory module 122 to store the data into the selected physical units. After storing the data into the physical units, the physical units may be associated with the data region 31. In other words, one or more physical units may be alternately used between the data region 31 and the free region 32.

In an embodiment, the memory control circuit 23 may be provided with a plurality of logical units 302(1) to 302(C) to map the physical units (i.e., physical units 301(1) to 301(A)) in the data region 31. For example, a logical unit may correspond to a logical block address (LBA) or other logical management units. A logical unit may be mapped to one or more physical units.

In an embodiment, if a specific physical unit is currently mapped by any logical unit, the memory control circuit 23 may determine that the data currently stored in the physical unit includes the valid data. Conversely, if a specific physical unit is currently not mapped by any logical unit, the memory control circuit 23 may determine that the physical unit does not currently store any valid data.

In an embodiment, the memory control circuit 23 may record a mapping relationship between logical units and physical units in at least one management table (also referred to as a logical-to-physical mapping table). In an embodiment, the memory control circuit 23 may instruct the memory module 122 to perform operations such as data reading, writing, or erasing according to the information in the management table (i.e., the logical-to-physical mapping table).

In an embodiment, the memory control circuit 23 may detect an access event (also referred to as an access operation). The access event reflects that a specific physical unit (also referred to as a first physical unit) in the memory module 122 is accessed. For example, the access event may reflect that data is written into (i.e., stored in) the first physical unit or data is read from the first physical unit.

In an embodiment, the access event is generated or triggered in response to an access instruction (also referred to as an access command) from the host system 11. The access instruction may instruct to access at least one logical unit. The at least one logical unit may be mapped to the first physical unit. In an embodiment, the access event is generated or triggered in response to a data compaction operation internal to the storage device 12. For example, the data compaction operation may include a garbage collection (GC) operation, a wear leveling (WL) operation, or other types of data compaction (e.g., data migration) operations.

In an embodiment, based on the access event, the memory control circuit 23 may determine, through a Cuckoo filter, whether a hit event corresponding to the first physical unit has occurred. For example, the Cuckoo filter may record fingerprint information corresponding to at least some of the physical units in the memory module 122. In an embodiment, if the fingerprint information corresponding to a specific physical unit is currently recorded in the Cuckoo filter, it indicates that the physical unit has a high probability of having been accessed (e.g., having undergone a write operation and/or a read operation) recently (or within a time range that includes the current time).

In an embodiment, based on the access event, the memory control circuit 23 may obtain identification information (i.e., first identification information) corresponding to the first physical unit. For example, each of identification information may be used to exclusively represent a single physical unit in the memory module 122. For example, the identification information may include a unit number (also referred to as a block number), a unit name (also referred to as a block name), or other types of identification data of the physical unit. Then, the memory control circuit 23 may process the first identification information through a plurality of hash generators to obtain fingerprint information (also referred to as first fingerprint information) corresponding to the first physical unit and a plurality of index information. Similar to the first identification information, the first fingerprint information may be used to identify the first physical unit.

In an embodiment, the Cuckoo filter includes a bucket structure. The bucket structure may include a plurality of buckets, and each bucket may include a plurality of entries. Each entry may be used to store fingerprint information corresponding to a specific physical unit. It should be noted that, in an embodiment, an information length of at least some of the fingerprint information stored in the bucket structure (or Cuckoo filter) may be dynamically set or dynamically adjusted by the memory control circuit 23.

In an embodiment, after obtaining the first fingerprint information and the plurality of index information, the memory control circuit 23 may query the bucket structure in the Cuckoo filter through the plurality of index information to determine a plurality of buckets (also referred to as target buckets) in the bucket structure. For example, a total of two target buckets may be provided, wherein one target bucket may be referred to as a primary bucket, and the other target bucket may be referred to as an alternate bucket.

In an embodiment, after determining the target buckets, the memory control circuit 23 may compare the first fingerprint information with the entry content (i.e., the fingerprint information stored in the target buckets) in the target buckets to obtain a comparison result. The comparison result may reflect whether the first fingerprint information is identical to the entry content in the target buckets. Then, the memory control circuit 23 may determine, based on the comparison result, whether the hit event corresponding to the first physical unit has occurred.

In an embodiment, if the comparison result reflects that the first fingerprint information is identical to the entry content in the target buckets, the memory control circuit 23 may determine that the hit event corresponding to the first physical unit has occurred. In an embodiment, if the comparison result reflects that the first fingerprint information is different from the entry content in the target buckets, the memory control circuit 23 may determine that the hit event corresponding to the first physical unit has not occurred.

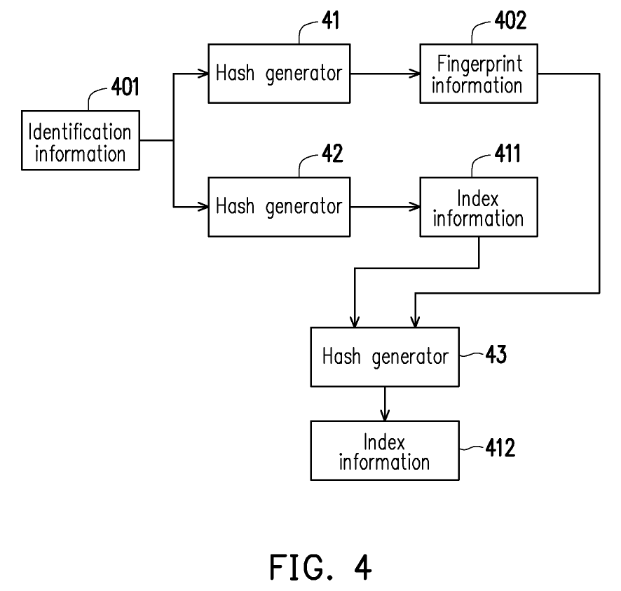

FIG. 4 is a schematic diagram illustrating generating first fingerprint information and a plurality of index information based on first identification information according to an embodiment of the present disclosure. Please refer to FIG. 4, assume that the first identification information includes identification information 401. For example, the identification information 401 corresponds to one of the physical units 301(1) to 301(B) of FIG. 3.

In an embodiment, the memory control circuit 23 may obtain the identification information 401 based on the access event. After obtaining the identification information 401, the memory control circuit 23 may input the identification information 401 into hash generators 41 and 42 to obtain fingerprint information 402 (i.e., the first fingerprint information) and index information 411. For example, the hash generators 41 and 42 may process (i.e., perform hash operations on) the identification information 401 respectively through different hash algorithms (e.g., different hash functions) to generate the fingerprint information 402 and the index information 411. That is, the memory control circuit 23 may obtain the fingerprint information 402 and the index information 411 respectively based on the outputs of the hash generators 41 and 42.

After obtaining the fingerprint information 402 and the index information 411, the memory control circuit 23 may input the fingerprint information 402 and the index information 411 into a hash generator 43 to obtain index information 412. For example, the hash generator 43 may include a composite arithmetic unit. The composite arithmetic unit may first perform a hash operation on the fingerprint information 402 to obtain hash information corresponding to the fingerprint information 402. Then, the composite arithmetic unit may perform an exclusive OR (XOR) operation on the index information 411 and the hash information corresponding to the fingerprint information 402 to obtain the index information 412.

It should be noted that, for different types of Cuckoo filters and/or practical requirements, the generation methods of the fingerprint information 402, the index information 411, and the index information 412 may be dynamically adjusted, and are not limited to the generation methods described in the embodiment of FIG. 4.

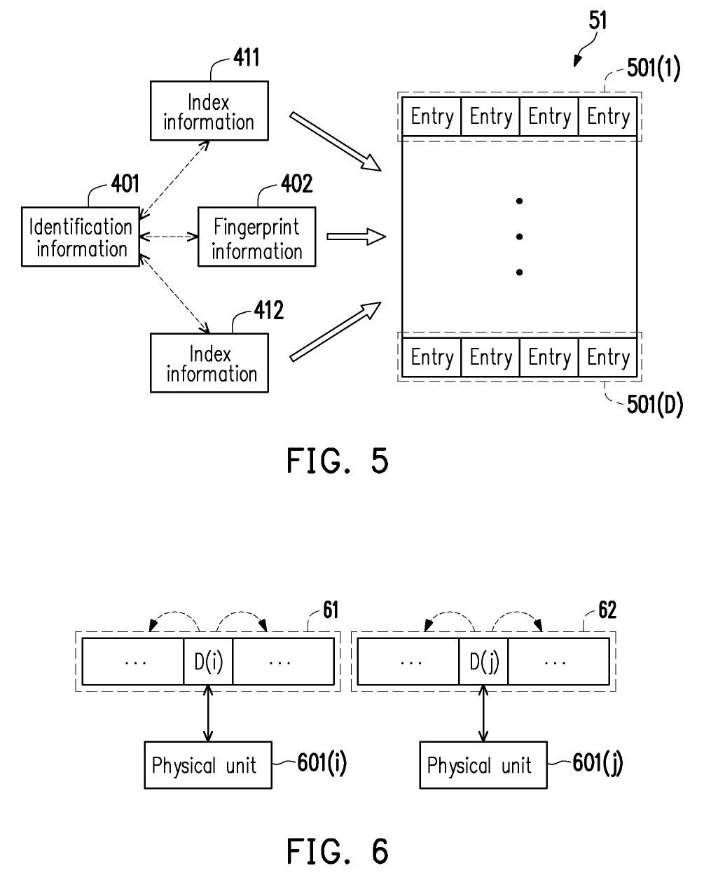

FIG. 5 is a schematic diagram illustrating querying the bucket structure of the Cuckoo filter according to an embodiment of the present disclosure. Please refer to FIG. 5, assume that the Cuckoo filter includes a bucket structure 51. The bucket structure 51 includes a plurality of buckets 501(1) to 501(D). D may be any value greater than 1. Each bucket in the bucket structure 51 may include a plurality of entries. Taking FIG. 5 as an example, each bucket in the bucket structure 51 includes 4 entries. Each entry may be provided to store fingerprint information corresponding to a specific physical unit. In addition, each entry may be empty (i.e., no fingerprint information has been stored yet) or occupied (i.e., fingerprint information has been stored). It should be noted that the total number of buckets 501(1) to 501(D) and the total number of entries included in each of the buckets may both be adjusted according to practical requirements.

In an embodiment, after obtaining the fingerprint information 402, the index information 411, and the index information 412 corresponding to the identification information 401, the memory control circuit 23 may query the bucket structure 51 through the index information 411 and the index information 412 to determine the plurality of target buckets in the bucket structure 51. For example, based on the index information 411, the memory control circuit 23 may determine a bucket 501(k) in the bucket structure 51 as one (e.g., the primary bucket) of the target buckets. Based on the index information 412, the memory control circuit 23 may determine a bucket 501(s) in the bucket structure 51 as another one (e.g., the alternate bucket) of the target buckets.

After determining the target buckets, the memory control circuit 23 may compare the fingerprint information 402 with the entry content in the target buckets to obtain a comparison result. For example, the comparison result may reflect whether the fingerprint information 402 is identical to the entry content in the target buckets. Then, the memory control circuit 23 may determine, based on the comparison result, whether the hit event corresponding to the first physical unit has occurred.

In an embodiment, if it is determined that the hit event corresponding to the first physical unit has not occurred, it indicates that the fingerprint information (i.e., the first fingerprint information) corresponding to the first physical unit has not yet been stored in the Cuckoo filter. In this case, the memory control circuit 23 may add (i.e., store) the fingerprint information (i.e., the first fingerprint information) corresponding to the first physical unit into the Cuckoo filter (e.g., the bucket structure 51 of FIG. 5). For example, the memory control circuit 23 may store the first fingerprint information into the target buckets through the index information 411 and the index information 412. It should be noted that, if there are no empty entries in the target buckets, the memory control circuit 23 may migrate data from the target buckets to other buckets in the bucket structure 51 to free up storage space in the target buckets. Then, the memory control circuit 23 may store the first fingerprint information into the target buckets.

In an embodiment, if it is determined that the hit event corresponding to the first physical unit has occurred, the memory control circuit 23 may update hit count information corresponding to the first physical unit. For example, the hit count information may reflect the total number of times that the hit event corresponding to the first physical unit has occurred, as determined through the Cuckoo filter, within an elapsed period of time (also referred to as a preset time range). For example, the hit count information includes a count value. Within the preset time range, whenever the hit event corresponding to the first physical unit occurs, the memory control circuit 23 may increment the count value by "1" to update the hit count information corresponding to the first physical unit. However, if the hit event corresponding to the first physical unit has not occurred, the memory control circuit 23 may not update the hit count information corresponding to the first physical unit.

In an embodiment, the memory control circuit 23 may determine whether the hit count information corresponding to the first physical unit meets a preset condition. For example, the memory control circuit 23 may determine whether the count value is greater than or equal to a threshold value (e.g., 2 or a larger integer). If the count value is greater than or equal to the threshold value, the memory control circuit 23 may determine that the hit count information corresponding to the first physical unit meets the preset condition. However, if the count value is less than the threshold value, the memory control circuit 23 may determine that the hit count information corresponding to the first physical unit does not meet the preset condition.

In an embodiment, the memory control circuit 23 may be provided with a plurality of information queues. Each information queue may be provided for storage of a plurality of identification information. Each identification information may correspond to a physical unit in the memory module 122. For example, the plurality of information queues may include a first information queue and a second information queue. In an embodiment, the memory control circuit 23 may manage and classify physical units with different access counts and/or access frequencies through the first information queue and the second information queue.

In an embodiment, assume that the first identification information corresponding to the first physical unit does not currently exist in the first information queue. In this case, after determining that the hit event corresponding to the first physical unit has occurred, the memory control circuit 23 may automatically store (e.g., add) the first identification information corresponding to the first physical unit into the first information queue.

In an embodiment, assume that the first identification information corresponding to the first physical unit already exists in the first information queue. In this case, if the hit count information corresponding to the first physical unit meets the preset condition (e.g., the first physical unit has been hit multiple times), the memory control circuit 23 may automatically migrate the first identification information corresponding to the first physical unit from the first information queue to the second information queue.

In an embodiment, assume that the first identification information corresponding to the first physical unit already exists in the first information queue. In this case, if the hit count information corresponding to the first physical unit does not meet the preset condition (e.g., the first physical unit has not been hit multiple times), the memory control circuit 23 may continue to store the first identification information corresponding to the first physical unit in the first information queue (i.e., without migrating the first identification information to the second information queue).

In an embodiment, the above-mentioned operations may be regarded as a two-stage verification operation for the first physical unit. Specifically, in a first-stage verification operation, the Cuckoo filter is provided to preliminarily determine whether the first physical unit belongs to a physical unit that has been repeatedly accessed recently. For example, if the hit event corresponding to the first physical unit is determined to have occurred through the Cuckoo filter, it indicates that the first physical unit belongs to a physical unit that has been accessed recently. However, if the hit event corresponding to the first physical unit is determined to have not occurred through the Cuckoo filter, it indicates that the first physical unit belongs to a physical unit that has not been accessed for a long time.

If the first physical unit belongs to the physical unit that has been accessed recently (i.e., the hit event corresponding to the first physical unit is determined to have occurred through the Cuckoo filter), a second-stage verification operation corresponding to the first physical unit may be subsequently performed. In the second-stage verification operation, based on the hit count information corresponding to the first physical unit, it may be further determined whether the first physical unit has indeed been accessed multiple times within the corresponding preset time range. For example, the preset time range may be calculated from the time when each identification information is stored into the first information queue.

If a result of the second-stage verification operation reflects that the first physical unit has been accessed multiple times within the preset time range, it indicates that the data stored in the first physical unit has a higher probability of belonging to hot data with a higher access frequency. Therefore, the first identification information corresponding to the first physical unit may be migrated from the first information queue to the second information queue. In addition, if a result of the second-stage verification operation reflects that the first physical unit has not been accessed multiple times within the preset time range, it indicates that the data stored in the first physical unit has a higher probability of belonging to cold data that is accessed only once in a long while. Therefore, the first identification information corresponding to the first physical unit may be temporarily retained in the first information queue.

In an embodiment, the memory control circuit 23 may classify at least some physical units in the memory module 122 into first-type physical units and second-type physical units. In particular, a wear level of the second-type physical units is higher than a wear level of the first-type physical units. For example, a usage count value of the second-type physical units may be greater than a usage count value of the first-type physical units. For example, a usage count value of a physical unit may be obtained based on read counts, program (also referred to as programming) counts, and/or erase counts of the physical unit. The read count of a physical unit may reflect how many read operations have been performed on the physical unit. The program count of a physical unit may reflect how many program operations have been performed on the physical unit. The erase count of a physical unit may reflect how many erase operations have been performed on the physical unit. For example, the usage count value of a physical unit may be positively correlated with the read count, the program count, and/or the erase count of the physical unit.

In an embodiment, the memory control circuit 23 may perform a data compaction operation (also referred to as a first data compaction operation) on at least one corresponding physical unit in the memory module 122 based on at least one identification information stored in the second information queue. For example, assume that the second information queue stores identification information (also referred to as second identification information) corresponding to a specific physical unit (also referred to as a second physical unit) in the memory module 122. In the first data compaction operation, based on the second identification information, the memory control circuit 23 may migrate the valid data stored in the second physical unit to the first-type physical unit with a relatively lower wear level.

In an embodiment, the memory control circuit 23 may further perform a data compaction operation (also referred to as a second data compaction operation) on at least one corresponding physical unit in the memory module 122 based on at least one identification information stored in the first information queue. For example, assume that the first information queue stores identification information (also referred to as third identification information) corresponding to a specific physical unit (also referred to as a third physical unit) in the memory module 122. In the second data compaction operation, based on the third identification information, the memory control circuit 23 may migrate the valid data stored in the third physical unit to the second-type physical unit with a relatively higher wear level.

FIG. 6 is a schematic diagram of the first information queue and the second information queue according to an embodiment of the present disclosure. Referring to FIG. 6, assume that the first information queue and the second information queue are a queue 61 and a queue 62, respectively. Identification information D(i) (i.e., the third identification information) is stored in the queue 61. Identification information D(j) (i.e., the second identification information) is stored in the queue 62. The identification information D(i) corresponds to a physical unit 601(i) (i.e., the third physical unit). The identification information D(j) corresponds to a physical unit 601(j) (i.e., the second physical unit).

In an embodiment, the memory control circuit 23 may migrate the valid data stored in the physical unit 601(j) to the first-type physical unit with a relatively lower wear level based on the identification information D(j). In an embodiment, the memory control circuit 23 may migrate the valid data stored in the physical unit 601(i) to the second-type physical unit with a relatively higher wear level based on the identification information D(i).

In an embodiment, the memory control circuit 23 may further move a position of the identification information D(i) in the queue 61 based on the number of times and/or frequency that the physical unit 601(i) is accessed to further determine whether to remove the identification information D(i) from the queue 61 or to further differentiate the hot and cold characteristics of the data stored in the physical unit 601(i). In an embodiment, the memory control circuit 23 may further move a position of the identification information D(j) in the queue 62 based on the number of times and/or frequency that the physical unit 601(j) is accessed to further determine whether to remove the identification information D(j) from the queue 62 or to further differentiate the hot and cold characteristics of the data stored in the physical unit 601(j).

In an embodiment, each fingerprint information stored in the Cuckoo filter may have a specific information length. For example, the information length may be represented by n bits (n-bits). For example, n may be 8, 12, or other integers greater than 1. In an embodiment, the Cuckoo filter may be provided to store at least two items of fingerprint information with different information lengths.

In an embodiment, the memory control circuit 23 may further count the number of times of use and/or frequency of use of the fingerprint information (i.e., the first fingerprint information) corresponding to the first physical unit. Then, the memory control circuit 23 may adjust the information length of the first fingerprint information stored in the Cuckoo filter based on the number of times of use and/or frequency of use of the first fingerprint information.

In an embodiment, the memory control circuit 23 may determine the type of the first fingerprint information based on the number of times of use and/or frequency of use of the first fingerprint information. Then, the memory control circuit 23 may adjust the information length of the first fingerprint information stored in the Cuckoo filter based on the type of the first fingerprint information.

In an embodiment, if the number of times of use and/or frequency of use of the first fingerprint information is not higher than a threshold value, the memory control circuit 23 may determine that the first fingerprint information belongs to first-type fingerprint information (also referred to as low-frequency fingerprint). However, if the number of times of use and/or frequency of use of the first fingerprint information is higher than the threshold value, the memory control circuit 23 may determine that the first fingerprint information belongs to second-type fingerprint information (also referred to as high-frequency fingerprint).

In an embodiment, if the first fingerprint information belongs to the first-type fingerprint information (i.e., low-frequency fingerprint), the memory control circuit 23 may set the information length of the first fingerprint information to a specific length (also referred to as a first length). However, if the first fingerprint information belongs to the second-type fingerprint information (i.e., high-frequency fingerprint), the memory control circuit 23 may set the information length of the first fingerprint information to another length (also referred to as a second length). The number of bits of the second length is greater than the number of bits of the first length. For example, assuming that the number of bits of the first length is 8 bits (i.e., 8-bits), the number of bits of the second length may be 12 bits (i.e., 12-bits) or more bits.

In an embodiment, the memory control circuit 23 may change the information length of the first fingerprint information currently or subsequently stored in the Cuckoo filter based on the number of times of use and/or frequency of use of the first fingerprint information. Taking FIG. 4 as an example, the memory control circuit 23 may generate the fingerprint information 402 with different information lengths by adjusting the hash algorithm adopted by the hash generator 41.

In an embodiment of FIG. 4, assume that the first fingerprint information currently stored in the bucket structure 51 has the first length. If the first fingerprint information changes from belonging to the first-type fingerprint information (i.e., low-frequency fingerprint) to belonging to the second-type fingerprint information (i.e., high-frequency fingerprint), the memory control circuit 23 may adjust the hash algorithm adopted by the hash generator 41, and instruct the hash generator 41 to regenerate the fingerprint information 402 with the second length based on the adjusted hash algorithm. Alternatively, in an embodiment, the memory control circuit 23 may also control other hash generators to generate the fingerprint information 402 with the second length. Then, the memory control circuit 23 may re-store the fingerprint information 402 with the second length into the bucket structure 51 to replace the original fingerprint information 402 (i.e., the old fingerprint information 402) with the first length in the bucket structure 51.

In an embodiment, the memory control circuit 23 may further monitor at least one of the wear level, current data volume, and data volume change of the memory module 122. Then, the memory control circuit 23 may dynamically adjust the capacity of at least one of the first information queue and the second information queue based on at least one of the wear level, current data volume, and data volume change of the memory module 122.

In an embodiment, the memory control circuit 23 may determine the wear level of the memory module 122 based on the remaining number of reserved physical units in the memory module 122. When the storage device 12 leaves the factory, some physical units in the memory module 122 are set as reserved physical units. The physical units set as reserved physical units are preset to not be used. However, in some situations, the memory control circuit 23 may use the reserved physical units. For example, when a specific physical unit is detected to be damaged (i.e., not suitable for continued use), the memory control circuit 23 may use a reserved physical unit to replace the damaged physical unit to avoid a reduction in the available storage space of the memory module 122. Alternatively, the memory control circuit 23 may also customize other usage scenarios to temporarily or permanently use the reserved physical units.

In an embodiment, if the wear level of the memory module 122 reflects that the remaining number of reserved physical units in the memory module 122 is not less than a preset number, the memory control circuit 23 may set the capacity of the first information queue and/or the second information queue to a specific capacity (also referred to as a first capacity). However, if the wear level of the memory module 122 reflects that the remaining number of reserved physical units in the memory module 122 is less than the preset number, the memory control circuit 23 may set the capacity of the first information queue and/or the second information queue to another capacity (also referred to as a second capacity). The first capacity and the second capacity may be set according to practical requirements.

In an embodiment, the memory control circuit 23 may also determine the wear level of the memory module 122 based on an average wear level, a maximum wear level, and/or a minimum wear level of at least some physical units in the memory module 122. For example, the average wear level may reflect an average value of the read count, the program count, and/or the erase count of at least some physical units in the memory module 122. The maximum wear level may reflect a maximum value of the read count, the program count, and/or the erase count of at least some physical units in the memory module 122. The minimum wear level may reflect a minimum value of the read count, the program count, and/or the erase count of at least some physical units in the memory module 122.

In an embodiment, if the current data volume of the memory module 122 is greater than a data volume threshold and/or the data volume change of the memory module 122 reflects that an increase in the data volume of the memory module 122 exceeds a preset magnitude, the memory control circuit 23 may correspondingly increase the capacity of the second information queue (and the first information queue).

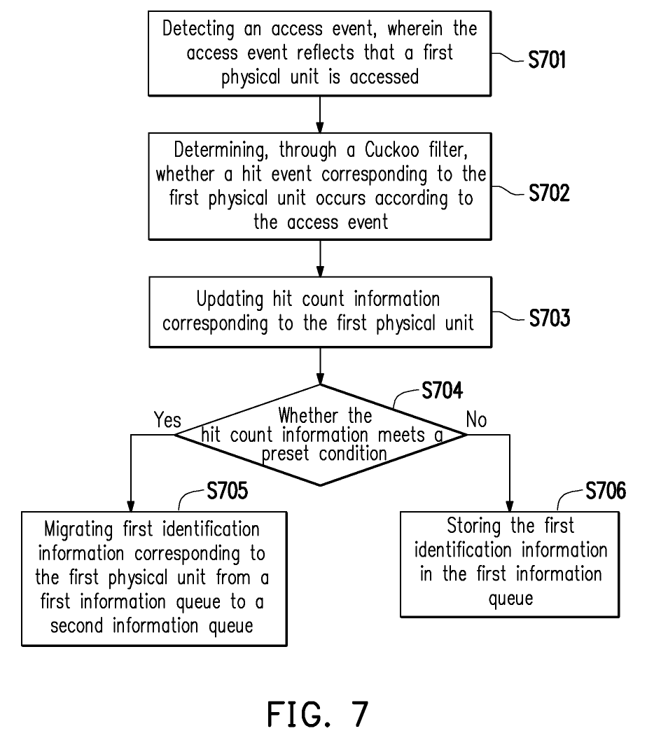

FIG. 7 is a flowchart of a memory management method according to an embodiment of the present disclosure. Referring to FIG. 7, in step S701, the access event is detected, wherein the access event reflects that the first physical unit in the memory module is accessed. In step S702, based on the access event, it is determined whether the hit event corresponding to the first physical unit occurs through the Cuckoo filter. In step S703, if the hit event occurs, the hit count information corresponding to the first physical unit is updated. In step S704, it is determined whether the hit count information corresponding to the first physical unit meets the preset condition. If the hit count information meets the preset condition, in step S705, the first identification information corresponding to the first physical unit is migrated from the first information queue to the second information queue. In addition, if the hit count information does not meet the preset condition, in step S706, the first identification information is stored in the first information queue.

However, the steps in FIG. 7 have been described in detail above, and thus will not be repeated herein. It is worth noting that the steps in FIG. 7 may be implemented as multiple program codes or circuits, and the present disclosure is not limited thereto. In addition, the method of FIG. 7 may be used in conjunction with the above exemplary embodiments, or may be used alone, and the present disclosure is not limited thereto.

In summary, the embodiments of the present disclosure directed to the memory management method and the storage device are intended, through the integration of the advantages of Cuckoo hashing and the Adaptive Replacement Cache (ARC) algorithm, to provide a more intelligent and efficient scheme for hot/cold data classification and cache management. The method not only effectively reduces memory overhead and lowers the misclassification rate, but also better adapts to variations across differing workloads, thereby significantly enhancing the overall performance and operational lifespan of solid-state drives (SSDs).

Finally, it should be noted that the above embodiments are only used to illustrate the technical solutions of the present disclosure, rather than to limit the same. Although the present disclosure has been described in detail with reference to the foregoing embodiments, those of ordinary skill in the art should understand that modifications may still be made to the technical solutions described in the foregoing embodiments, or equivalent replacements may be made to some or all of the technical features therein; and such modifications or replacements do not cause the essence of the corresponding technical solutions to depart from the scope of the technical solutions of the embodiments of the present disclosure.

What is claimed is:

1. A memory management method for a storage device, wherein the storage device comprises a memory module, the memory module comprising a plurality of physical units, and the memory management method comprising:
detecting an access event, wherein the access event reflects that a first physical unit among the plurality of physical units is accessed;
determining, through a Cuckoo filter, whether a hit event corresponding to the first physical unit occurs according to the access event;
if the hit event occurs, updating hit count information corresponding to the first physical unit;
if the hit count information meets a preset condition, migrating first identification information corresponding to the first physical unit from a first information queue to a second information queue; and
if the hit count information does not meet the preset condition, storing the first identification information in the first information queue.

2. The memory management method according to claim 1, wherein the step of determining, through the Cuckoo filter, whether the hit event corresponding to the first physical unit occurs comprises:
processing the first identification information through a plurality of hash generators to obtain first fingerprint information and a plurality of index information corresponding to the first physical unit;
querying a bucket structure in the Cuckoo filter through the plurality of index information to determine a plurality of target buckets in the bucket structure;
comparing the first fingerprint information with entry contents in the plurality of target buckets to obtain a comparison result; and
determining, according to the comparison result, whether the hit event corresponding to the first physical unit occurs.

3. The memory management method according to claim 1, further comprising:
performing a first data compaction operation on a second physical unit among the plurality of physical units according to at least one identification information stored in the second information queue; and
in the first data compaction operation, migrating valid data stored in the second physical unit to a first-type physical unit.

4. The memory management method according to claim 3, further comprising:
performing a second data compaction operation on a third physical unit among the plurality of physical units according to at least one identification information stored in the first information queue; and
in the second data compaction operation, migrating valid data stored in the third physical unit to a second-type physical unit, wherein a wear level of the second-type physical unit is higher than a wear level of the first-type physical unit.

5. The memory management method according to claim 1, further comprising:
determining a type of first fingerprint information according to a number of times of use or a frequency of use of the first fingerprint information corresponding to the first physical unit; and
adjusting an information length of the first fingerprint information corresponding to the first physical unit in the Cuckoo filter according to the type of the first fingerprint information.

6. The memory management method according to claim 5, wherein the step of adjusting the information length of the first fingerprint information corresponding to the first physical unit in the Cuckoo filter according to the type of the first fingerprint information comprises:
if the first fingerprint information belongs to a first type of fingerprint information, setting the information length of the first fingerprint information to a first length; and
if the first fingerprint information belongs to a second type of fingerprint information, setting the information length of the first fingerprint information to a second length, wherein a number of bits of the second length is greater than a number of bits of the first length.

7. The memory management method according to claim 1, wherein the Cuckoo filter is configured to store at least two items of fingerprint information having different information lengths.

8. The memory management method according to claim 1, further comprising:
adjusting a capacity of at least one of the first information queue and the second information queue according to at least one of a wear level of the memory module, a current data volume, and a data volume change.

9. A storage device, comprising:
a connection interface, configured to connect to a host system;
a memory module; and
a memory controller, connected to the connection interface and the memory module,
wherein the memory module comprises a plurality of physical units, and the memory controller is configured to:
detect an access event, wherein the access event reflects that a first physical unit among the plurality of physical units is accessed;
determine, through a Cuckoo filter, whether a hit event corresponding to the first physical unit occurs according to the access event;
if the hit event occurs, update hit count information corresponding to the first physical unit;
if the hit count information meets a preset condition, migrate first identification information corresponding to the first physical unit from a first information queue to a second information queue; and
if the hit count information does not meet the preset condition, store the first identification information in the first information queue.

10. The storage device according to claim 9, wherein the operation of determining, through the Cuckoo filter, whether the hit event corresponding to the first physical unit occurs comprises:
processing the first identification information through a plurality of hash generators to obtain first fingerprint information and a plurality of index information corresponding to the first physical unit;
querying a bucket structure in the Cuckoo filter through the plurality of index information to determine a plurality of target buckets in the bucket structure;
comparing the first fingerprint information with entry contents in the plurality of target buckets to obtain a comparison result; and
determining, according to the comparison result, whether the hit event corresponding to the first physical unit occurs.

11. The storage device according to claim 9, wherein the memory controller is further configured to:
perform a first data compaction operation on a second physical unit among the plurality of physical units according to at least one identification information stored in the second information queue; and
in the first data compaction operation, migrate valid data stored in the second physical unit to a first-type physical unit.

12. The storage device according to claim 11, wherein the memory controller is further configured to:
perform a second data compaction operation on a third physical unit among the plurality of physical units according to at least one identification information stored in the first information queue; and
in the second data compaction operation, migrate valid data stored in the third physical unit to a second-type physical unit, wherein a wear level of the second-type physical unit is higher than a wear level of the first-type physical unit.

13. The storage device according to claim 9, wherein the memory controller is further configured to:
determine a type of first fingerprint information according to a number of times of use or a frequency of use of the first fingerprint information corresponding to the first physical unit; and
adjust an information length of the first fingerprint information corresponding to the first physical unit in the Cuckoo filter according to the type of the first fingerprint information.

14. The storage device according to claim 13, wherein the operation of adjusting the information length of the first fingerprint information corresponding to the first physical unit in the Cuckoo filter according to the type of the first fingerprint information comprises:
if the first fingerprint information belongs to a first type of fingerprint information, setting the information length of the first fingerprint information to a first length; and
if the first fingerprint information belongs to a second type of fingerprint information, setting the information length of the first fingerprint information to a second length, wherein a number of bits of the second length is greater than a number of bits of the first length.

15. The storage device according to claim 9, wherein the Cuckoo filter is configured to store at least two items of fingerprint information having different information lengths.

16. The storage device according to claim 9, wherein the memory controller is further configured to:
adjust a capacity of at least one of the first information queue and the second information queue according to at least one of a wear level of the memory module, a current data volume, and a data volume change.
